(19) United States
(12) Patent Application Publication
(10) Pub. No.: US 2013/0020887 A1
(43) Pub. Date: Jan. 24, 2013

(54) MOTOR AND RECORDING DISK DRIVING DEVICE INCLUDING THE SAME

(71) Applicant: Jin San Kim, Hwaseong (KR)

(72) Inventor: Jin San Kim, Hwaseong (KR)

(73) Assignee: SAMSUNG ELECTRO-MECHANICS CO., LTD., Suwon (KR)

(21) Appl. No.: 13/551,171

(22) Filed: Jul. 17, 2012

(30) Foreign Application Priority Data
Jul. 21, 2011 (KR) 10-2011-0072328

(51) Int. Cl. H02K 5/02

(52) U.S. Cl. 310/44

(57) ABSTRACT

There is provided a spindle motor capable of having improved coupling strength between components by adhering the components to each other using an adhesive containing a metal powder. The spindle motor includes: a shaft; and a rotor case fixedly mounted to the shaft to thereby rotate together therewith, wherein an adhesive containing a metal powder is interposed in a portion at which the rotor case is fixedly mounted to the shaft.

### CROSS-REFERENCE TO RELATED APPLICATIONS

This application claims the priority of Korean Patent Application No. 10-2011-0072328 filed on Jul. 21, 2011, in the Korean Intellectual Property Office, the disclosure of which is incorporated herein by reference.

### BACKGROUND OF THE INVENTION

1. Field of the Invention

The present invention relates to a motor and a recoding disk driving device including the same, and more particularly, to a motor capable of having improved coupling strength between components by adhering the components to each other using an adhesive containing a metal powder, and a recording disk driving device including the same.

2. Description of the Related Art

A hard disk drive (HDD), an information storage device, reads data stored on a disk or writes data to the disk using a read/write head.

This hard disk drive requires a disk driving device capable of driving the disk. As the disk driving device, a small-sized spindle motor is used.

As this small-sized spindle motor, a fluid dynamic bearing assembly has been used. A shaft, a rotating member of the fluid dynamic bearing assembly, and a sleeve, a fixed member thereof, include oil interposed therebetween, such that the shaft is supported by fluid pressure generated in the oil.

In the process of assembling this spindle motor, an area in which a rotor case fixedly mounted on the shaft and rotating together therewith contacts the shaft while being fixed thereto, is small, such that even though the rotor case is adhered to the shaft using a press-fitting method, an adhesive, and the like, a press-fitting part becomes loose and shear failure in an adhesion portion is generated, at the time of use for an extended period of time, thereby causing separation of the shaft.

In addition, an area in which a cover member fixedly mounted to a lower portion of the sleeve to thereby prevent leakage of fluid contacts the sleeve while being fixed thereto is small, such that even though the cover member is adhered to the sleeve using a press-fitting method, an adhesive, or the like, a press-fitting part may become loose and shear failure in an adhesion portion may be generated at the time of use for an extended period of time, thereby causing separation of the cover member.

Therefore, even though a contact area between two members is small, the development of an adhesive capable of firmly adhering two members to each other has been urgently demanded.

### SUMMARY OF THE INVENTION

An aspect of the present invention provides a motor capable of significantly reducing separation between members having a small contact area even at the time of use for an extended period of time by increasing shear failure strength using an adhesive containing a metal powder at the time of coupling between the members, and a recording disk driving device including the same.

According to an aspect of the present invention, there is provided a spindle motor including: a shaft; and a rotor case fixedly mounted to the shaft to thereby rotate together therewith, wherein a portion at which the rotor case is fixedly mounted to the shaft has an adhesive containing a metal powder interposed therein.

An edge portion of at least one of an outer peripheral surface of the shaft and an inner peripheral surface of the rotor case, on which the rotor case is fixedly mounted to the shaft, may be provided with at least one chamfer part, and the adhesive containing the metal powder may be applied to the chamfer part.

The chamfer part may be formed to have a ring shape along the outer peripheral surface of the shaft and the inner peripheral surface of the rotor case.

At least one of the outer peripheral surface of the shaft and the inner peripheral surface of the rotor case on which the rotor case is fixedly mounted to the shaft may be provided with at least one groove, and the adhesive containing the metal powder may be applied to the groove.

The groove may be formed to have a ring shape along the outer peripheral surface of the shaft or the inner peripheral surface of the rotor case.

The groove may be formed to have a screw thread shape along the outer peripheral surface of the shaft or the inner peripheral surface of the rotor case.

The rotor case may be press-fitted onto the shaft.

The rotor case may have an inner diameter larger than an outer diameter of the shaft.

According to another aspect of the present invention, there is provided a spindle motor including: a sleeve supporting a shaft; and a cover member fixedly mounted to a lower end of the sleeve to thereby prevent leakage of lubricating fluid, wherein a portion at which the cover member is fixedly mounted to the sleeve has an adhesive containing a metal powder interposed therein.

An edge portion of at least one of an inner peripheral surface of the sleeve and an outer peripheral surface of the cover member on which the cover member is fixedly mounted to the sleeve may be provided with at least one chamfer part, and the adhesive containing the metal powder may be applied to the chamfer part.

The chamfer part maybe formed to have a ring shape along the inner peripheral surface of the sleeve or the outer peripheral surface of the cover member.

At least one of the inner peripheral surface of the sleeve and the outer peripheral surface of the cover member on which the cover member is fixedly mounted to the sleeve maybe provided with at least one groove, and the adhesive containing the metal powder may be applied to the groove.

The groove maybe formed to have a ring shape along the inner peripheral surface of the sleeve or the outer peripheral surface of the cover member.

The groove may be formed to have a screw thread shape along the inner peripheral surface of the sleeve or the outer peripheral surface of the cover member.

The cover member may be press-fitted into the sleeve.

The sleeve may have an inner diameter larger than an outer diameter of the cover member.

According to another aspect of the present invention, there is provided a recording disk driving device including the spindle motor as described above rotating a recording disk.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a spindle motor according to an embodiment of the present invention;

FIG. 2 is an exploded cutaway perspective view showing a shaft and a rotor case included in the spindle motor according to the embodiment of the present invention;

FIG. 3 is a cutaway view showing an assembled state between a shaft and a rotor case included in the spindle motor according to the embodiment of the present invention;

FIG. 4 is an exploded cutaway perspective view showing a sleeve and a cover member included in the spindle motor according to the embodiment of the present invention;

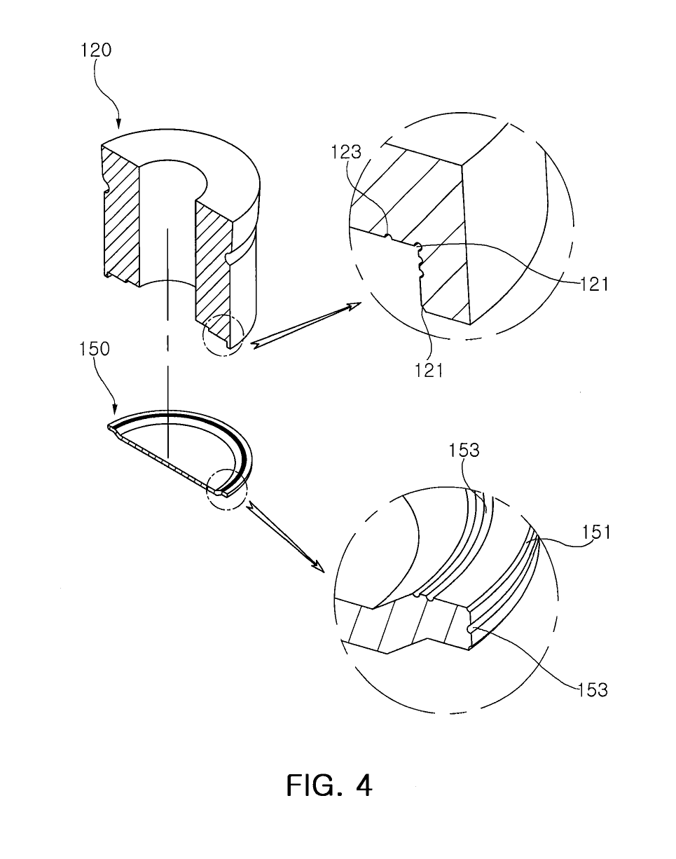

FIG. 5 is a view showing an assembled state between a sleeve and a cover member included in the spindle motor according to the embodiment of the present invention;

FIG. 6 is a schematic cross-sectional view of a recording disk driving device having the motor according to the embodiment of the present invention mounted therein;

FIG. 7, which is a partially enlarged view of FIG. 1, is a cross-sectional view showing a shape of an applied adhesive in a specimen provided in order to test adhesive strength of the motor according to the embodiment of the present invention; and

FIG. 8 is a graph showing a difference in separation force between a case (X) in which an epoxy bond is used as an adhesive and a case (Y) in which an epoxy bond containing a metal powder is used as an adhesive, in the specimen of FIG. 7.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are to be construed as being included in the spirit of the present invention.

Further, like reference numerals will be used to designate like components having similar functions throughout the drawings within the scope of the present invention.

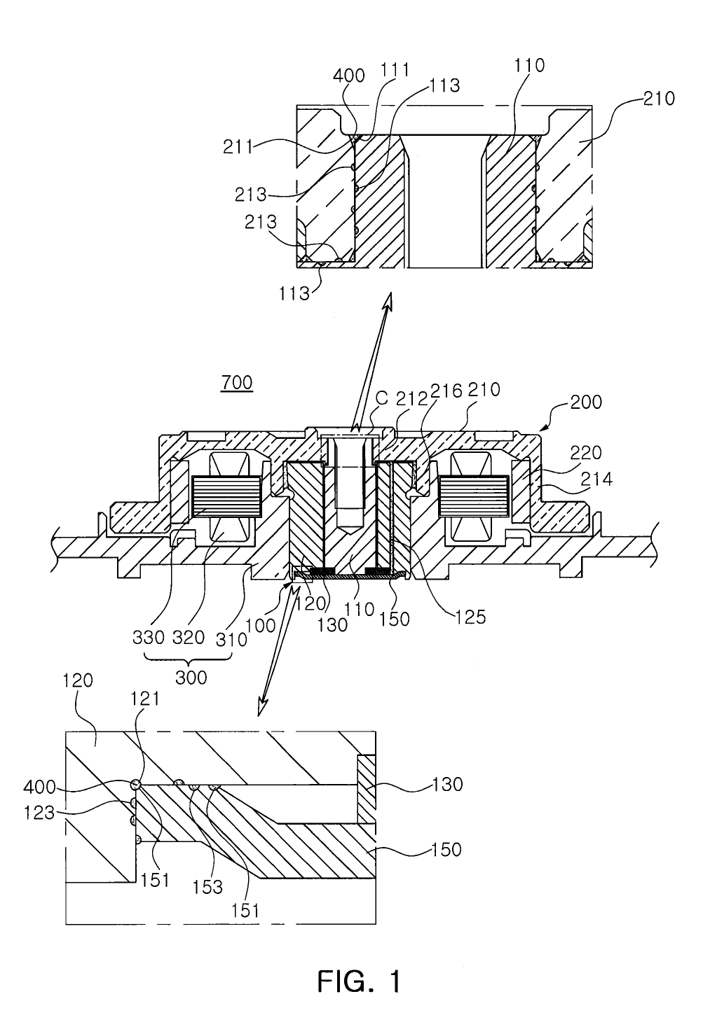

FIG. 1 is a cross-sectional view schematically showing a motor according to an embodiment of the present invention.

Referring to FIG. 1, a motor 700 according to an embodiment of the present invention may include a fluid dynamic bearing assembly 100 including a shaft 110 and a sleeve 120, a rotor 200 including a rotor case 210, and a stator 300 including a base member 310.

Hereinafter, the above configuration will be described in detail.

The fluid dynamic bearing assembly 100 may include the shaft 110, the sleeve 120, a thrust plate 130, and a cover member 150.

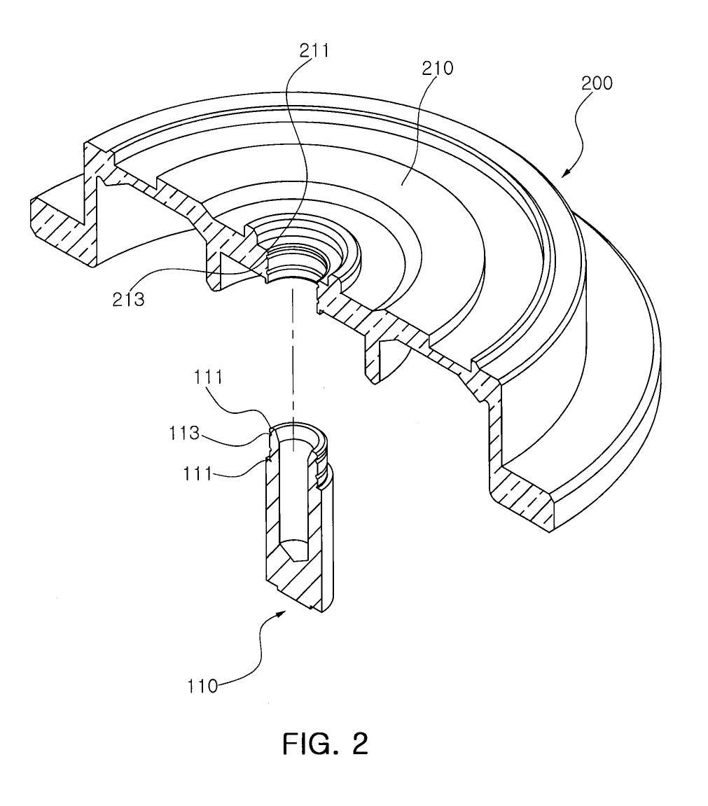

Terms with respect to directions will be first defined. As viewed in FIGS. 1 and 2, an axial direction refers to a vertical direction based on the shaft 110, and an outer diameter or inner diameter direction refers to a direction towards an outer edge of the rotor 200 based on the shaft 110 or a direction towards the center of the shaft 110 based on the outer edge of the rotor 200.

In addition, an inner peripheral surface of any member indicates a peripheral surface of a hole or a groove in the case in which the hole or the groove is formed in the member, and an outer peripheral surface of any member indicates the entire outer surface of the member. Further, when another member is inserted into one member, the entire portion in which one member having another member inserted thereinto contacts or faces another member is called an inner peripheral surface.

Further, an edge of any member, which indicates a portion forming a boundary of each surface, includes all protruded or depressed portions.

The sleeve 120 may support the shaft 110 such that an upper end of the shaft 110 protrudes upwardly in an axial direction, and may be formed by forging Cu or Al or sintering Cu—Fe based alloy powders or SUS based powders.

In this configuration, the shaft 110 may be inserted to have a micro clearance with a shaft hole of the sleeve 120. The micro clearance is filled with lubricating fluid, and the rotation of the rotor 200 may be more smoothly supported by a radial dynamic groove formed in at least one of an outer peripheral surface of the shaft 110 and an inner peripheral surface of the sleeve 120.

The radial dynamic groove may be formed in an inner side of the sleeve 120, which is an inner portion of the shaft hole of the sleeve 120, and may generate pressure so as to be deflected toward one side at the time of rotation of the shaft 110.

However, the radial dynamic groove is not limited to being formed in the inner side of the sleeve 120 as described above but may also be formed in an outer peripheral surface portion of the shaft 110. In addition, the number of radial dynamic grooves is not limited.

The sleeve 120 may include a bypass channel 125 formed therein so as to allow upper and lower portions thereof to be in communication with each other to disperse pressure of the lubricating fluid in an inner portion of the fluid dynamic bearing assembly 100, thereby maintaining balance in the pressure, and may move air bubbles, or the like, existing in the inner portion of the fluid dynamic bearing assembly 100 so as to be discharged by circulation.

Here, the sleeve 120 may include a cover member 150 coupled thereto at a lower portion thereof in the axial direction, having a clearance therebetween, wherein the clearance receives the lubricating fluid therein.

The cover member 150 may receive the lubricating fluid in the clearance between the cover member 150 and the sleeve 120 to thereby serve as a bearing supporting a lower surface of the shaft 110.

Since the cover member 150 has a significantly thin thickness in a portion in which it is coupled to the sleeve 120, a coupling area therebetween is small, such that coupling strength may not be secured. According to the embodiment of the present invention, the cover member 150 and the sleeve 120 may be adhered to each other using an adhesive containing a metal powder to thereby secure coupling strength. A detailed description thereof will be provided with reference to the accompanying drawings.

The thrust plate 130 may be disposed at an upper portion or a lower portion of the sleeve 120 in the axial direction (in the present invention, only a case in which the thrust plate is provided at the lower portion of the sleeve is shown for convenience, and hereinafter, a description will be provided based on this case) and may include a hole corresponding to a cross section of the shaft 110 at the center thereof, wherein the hole may include the shaft 110 inserted thereinto.

Here, the thrust plate 130 may be separately manufactured and be then coupled to the shaft 110 or may be integrally formed with the shaft 110 at the time of the manufacturing, and may be rotated along the shaft 110 at the time of rotational movement.

That is, the thrust plate 130 may be coupled to the shaft 110 by a screwing scheme, a bonding scheme, a welding scheme, or the like and may include a thrust dynamic groove formed in at least one of upper and lower surfaces thereof, wherein the thrust dynamic groove provides thrust dynamic pressure to the shaft 110.

The thrust dynamic groove is not limited to being formed in the lower surface of the thrust plate 130 as described above but may also be formed in an upper surface of the cover member 150 corresponding to the lower surface of the thrust plate 130 or the sleeve 120 corresponding to the upper surface of the thrust plate 130.

Further, the rotor case 210 of the motor 700 according to the embodiment of the present invention may include a hub base 212 press-fitted into an upper end of the shaft 110 to thereby be fixed thereto and a magnet support part 214 extended from the hub base 212 in an outer diameter direction and bent downwardly in the axial direction to thereby support a magnet 220 of the rotor 200.

In addition, the rotor case 210 may include a main wall part 216 extended downwardly in the axial direction so that the lubricating fluid is sealed between the main wall part 216 and the sleeve 120.

An interval between the main wall part 216 and the sleeve 120 may be gradually widened downwardly in the axial direction in order to prevent the lubricating fluid from being leaked to the outside at the time of the driving of the motor. To this end, an outer peripheral surface of the sleeve 120 corresponding to the main wall part 216 may be tapered in an inner diameter direction thereof.

The rotor 200 is a rotational structure provided to be rotatable with respect to the stator 300 and may include a rotor case 210 having an annular ring-shaped magnet 220 provided on an outer peripheral surface thereof, wherein the annular ring-shaped magnet 220 corresponds to the core 330, having a predetermined interval therefrom.

In other words, the rotor case 210 may be a rotating member press-fitted onto the shaft 110 to thereby rotate together with the shaft 110.

Here, as the magnet 220, a permanent magnet generating magnetic force having predetermined strength by alternately magnetizing an N pole and an S pole thereof in a circumferential direction may be used.

In addition, the rotor case 210 may include the hub base 212 press-fitted onto an upper end of the shaft 110 or fixed thereto by an adhesive and the magnet support part 214 extended from the hub base 212 in the outer diameter direction and bent downwardly in the axial direction to thereby support the magnet 220 of the rotor 200.

Since the rotor case 210 has a relatively thin thickness at a portion at which it is coupled to the shaft 110, a coupling area therebetween is small, such that coupling strength may not be secured. According to the embodiment of the present invention, the rotor case 210 and the shaft 110 are adhered to each other using an adhesive containing a metal powder to thereby secure coupling strength. A detailed description thereof will be provided with reference to the accompanying drawings.

The stator 300 may include a coil 320, a core 330, and a base member 310.

In other words, the stator 300 is a fixed structure that includes a winding coil 320 generating electromagnetic force having a predetermined magnitude at the time of the application of power and a plurality of cores 330 having the winding coil 320 wound therearound.

The core 330 may be fixedly disposed on an upper portion of the base member 310 including a printed circuit board (not shown) having pattern circuits printed thereon, a plurality of coil holes having a predetermined size may be formed to penetrate through the base member 310 so as to expose the winding coil 320 downwardly in an upper surface of the base member 310 corresponding to the winding coil 320, and the winding coil 320 may be electrically connected to the printed circuit board (not shown) so that external power is supplied thereto.

The outer peripheral surface of the sleeve 120 may be press-fitted into the base member 310 to thereby be fixed thereto, and the core 330 having the coil 320 wound therearound may be inserted into the base member 310. In addition, the base member 310 and the sleeve 120 may be assembled by applying an adhesive to an inner surface of the base member 310 or an outer surface of the sleeve 120.

Here, the base member 310 may include upper and lower coupling grooves (not shown) formed as grooves in an inner peripheral surface thereof for coupling with the sleeve 120, wherein each of the upper and lower coupling grooves may have upper and lower adhesives filled therein and the upper and lower adhesives are formed of different materials.

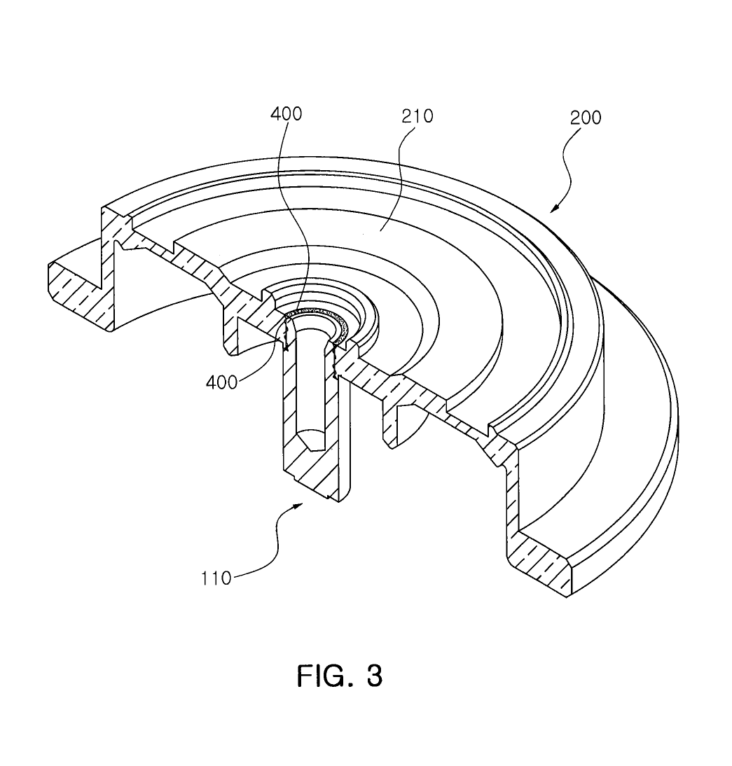

FIG. 2 is a cutaway exploded perspective view showing a shaft and a rotor case included in the spindle motor according to the embodiment of the present invention; and FIG. 3 is a view showing an assembled state between a shaft and a rotor case included in the spindle motor according to the embodiment of the present invention.

Referring to FIGS. 1 through 3, the spindle motor according to the embodiment of the present invention may include the shaft 110 and the rotor case 210 fixedly mounted to the shaft 110 to thereby rotate together with the shaft 110, wherein an adhesive 400 containing a metal powder is interposed in a portion at which the rotor case 210 is fixedly mounted to the shaft 110. The shaft 110 and the rotor case 210 are coupled to each other by the adhesive 400 containing the metal powder.

Basically, when the adhesive 400 containing the metal powder is applied to surfaces on which the shaft 110 and the rotor case 210 are coupled to each other and is then hardened, shear force is significantly enhanced. However, since there is a tolerance between an outer diameter of the shaft 110 and an inner diameter of the rotor case 210, when the shaft 110 is simply inserted into the rotor case 210, a defect does not occur; however, when the shaft 110 and the rotor case 210 are coupled to each other by a scheme such as a press-fitting scheme, or the like, it may be difficult to apply the adhesive 400 between the shaft 110 and the rotor case 210. Therefore, the shaft 110 and the rotor case 210 may include a chamfer part or a groove to be described below.

An edge portion of at least one of an outer peripheral surface of the shaft 110 and an inner peripheral surface of the rotor case 210 on which the rotor case 210 is fixedly mounted to the shaft 110 may be provided with at least one chamfer part ill or 211, and the adhesive 400 containing the metal powder may be applied to the chamfer part 111 or 211, whereby the shaft 110 and the rotor case 210 may be adhered to each other. The chamfer part 111 or 211 may be formed to have a ring shape along the outer peripheral surface of the shaft 110 or the inner peripheral surface of the rotor case 210 or be discontinuously formed along the outer peripheral surface of the shaft 110 or the inner peripheral surface of the rotor case 210.

In addition, at least one of the outer peripheral surface of the shaft 110 and the inner peripheral surface of the rotor case 210 on which the rotor case 210 is fixedly mounted to the shaft 110 may be provided with at least one groove 113 or 213, and the adhesive 400 containing the metal powder may be applied to the groove 113 or 213, whereby the shaft 110 and the rotor case 210 may be adhered to each other. The groove 113 or 213 may be formed to have a ring shape or a screw thread shape along the outer peripheral surface of the shaft 110 and the inner peripheral surface of the rotor case 210. Furthermore, the groove 113 or 213 may be formed as a simple groove in the outer peripheral surface of the shaft 110 and the inner peripheral surface of the rotor case 210.

In addition, the rotor case 210 may be fixed to the shaft 110 by the adhesive 400 containing the metal powder simultaneously with being press-fitted onto the shaft 110. The rotor case 210 may be formed to have an inner diameter larger than an outer diameter of the shaft 110, whereby the shaft 110 may be inserted into the rotor case 210 in a simple insertion scheme rather than the press-fitting scheme and then be adhered and fixed thereto by the adhesive 400 containing the metal powder.

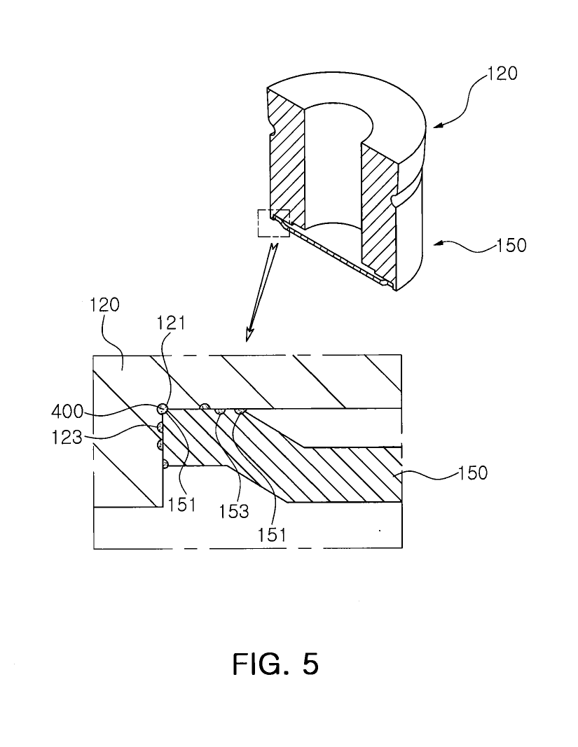

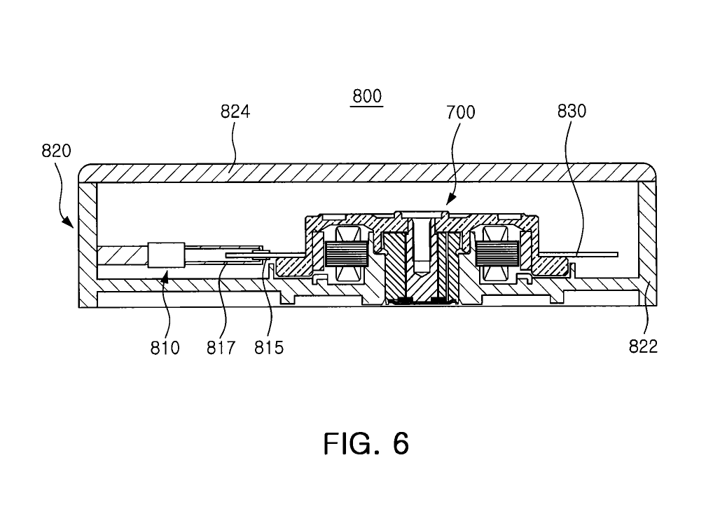

FIG. 5 is a view showing an assembled state between a sleeve and a cover member included in the spindle motor according to the embodiment of the present invention; and FIG. 6 is a schematic cross-sectional view of a recording disk driving device having the motor according to the embodiment of the present invention mounted therein.

Referring to FIGS. 1, 5 and 6, the spindle motor according to the embodiment of the present invention may include the sleeve 120 supporting the shaft 110 and the cover member 150 fixedly mounted to a lower end of the sleeve 120 to thereby prevent leakage of the lubricating fluid, wherein the adhesive 400 containing the metal powder is interposed in a portion at which the cover member 150 is fixedly mounted to the sleeve 120, whereby the sleeve 120 and the cover member 150 may be coupled to each other.

Basically, when the adhesive 400 containing the metal powder is applied to surfaces on which the sleeve 120 and the cover member 150 are coupled to each other and is then hardened, shear force is significantly enhanced. However, since there is a tolerance between an inner diameter of the sleeve 120 and an outer diameter of the cover member 150, when the cover member 150 is simply inserted into the sleeve 120, a defect does not occur; however, when the sleeve 120 and the cover member 150 are coupled to each other by a scheme such as a press-fitting scheme, or the like, it may be difficult to apply the adhesive 400 between the sleeve 120 and the cover member 150. Therefore, the sleeve 120 and the cover member 150 may include a chamfer part or a groove to be described below.

An edge portion of at least one of an inner peripheral surface of the sleeve 120 and an outer peripheral surface of the cover member 150 on which the cover member 150 is fixedly mounted to the sleeve 120 may be provided with at least one chamfer part 121 or 151, and the adhesive 400 containing the metal powder may be applied to the chamfer part 121 or 151, whereby the sleeve 120 and the cover member 150 may be adhered to each other. The chamfer part 121 or 151 may be formed to have a ring shape along the inner peripheral surface of the sleeve 120 or the outer peripheral surface of the cover member 150 or may be discontinuously formed along the inner peripheral surface of the sleeve 120 or the outer peripheral surface of the cover member 150.

In addition, at least one of an inner peripheral surface of the sleeve 120 and an outer peripheral surface of the cover member 150 on which the cover member 150 is fixedly mounted to the sleeve 120 may be provided with at least one groove 123 or 153, and the adhesive 400 containing the metal powder may be applied to the groove 123 or 153, whereby the sleeve 120 and the cover member 150 may be adhered to each other. The groove 123 or 153 may be formed to have a ring shape or a screw thread shape along the inner peripheral surface of the sleeve 120 and the outer peripheral surface of the cover member 150. Furthermore, the groove 123 or 153 may be formed as a simple groove in the inner peripheral surface of the sleeve 120 and the outer peripheral surface of the cover member 150.

In addition, the cover member 150 may be fixed to the sleeve 120 by the adhesive 400 containing the metal powder simultaneously with being press-fitted into the sleeve 120. The sleeve 120 may be formed to have an inner diameter larger than an outer diameter of the cover member 150, whereby the cover member 150 may be inserted into the sleeve 120 in a simple insertion scheme rather than the press-fitting scheme to then be adhered and fixed thereto by the adhesive 400 containing the metal powder.

FIG. 6 is a schematic cross-sectional view of a recording disk driving device having a motor according to the embodiment of the present invention mounted therein.

Referring to FIG. 6, a recording disk driving device 800 having the motor 700 according to the embodiment of the present invention mounted therein is a hard disk driving device and may include the motor 700, a head transfer part 810, and a housing 820.

The motor 700 has all the characteristics of the motor according to the embodiment of the present invention described above and may have a recording disk 830 mounted thereon.

The head transfer part 810 may transfer a head 815 detecting information of the recording disk 830 mounted in the motor 700 to a surface of the recording disk of which the information is to be detected.

Here, the head 815 may be disposed on a support portion 817 of the head transfer part 810.

The housing 820 may include a motor mounting plate 822 and a top cover 824 shielding an upper portion of the motor mounting plate 822 in order to form an internal space receiving the motor 700 and the head transfer part 810.

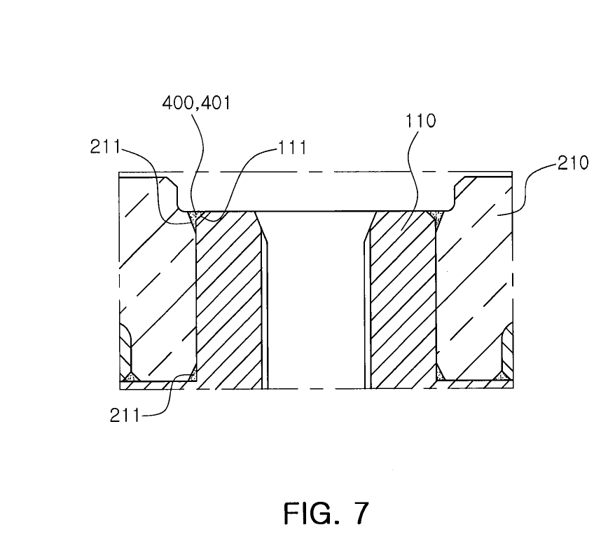

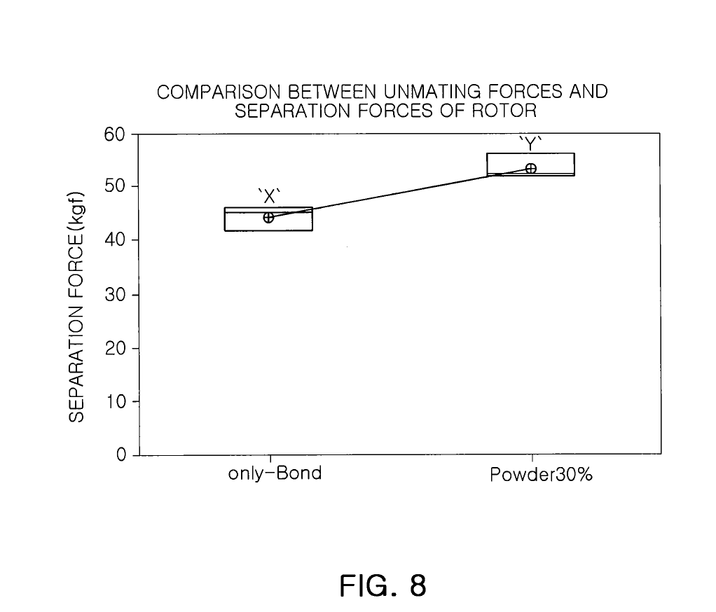

FIG. 7, which is a partially enlarged view of FIG. 1, is a cross-sectional view showing a shape of an applied adhesive in a specimen provided in order to test adhesive strength of the motor according to the embodiment of the present invention; and FIG. 8 is a graph showing a difference in separation force between a case (X) in which an epoxy bond is used as an adhesive and a case (Y) in which an epoxy bond containing a metal powder is used as an adhesive, in the specimen of FIG. 7.

Referring to FIG. 7, a part ‘C’ of FIG. 1 includes the shaft 110 and the rotor case 210 fixedly mounted to the shaft 110 to thereby rotate together with the shaft 110, wherein an epoxy adhesive or an epoxy adhesive containing a metal powder is interposed in a portion at which the rotor case 210 is fixedly mounted to the shaft 110, whereby the rotor case 210 and the shaft are adhered to each other.

In order to confirm the performance of the adhesive containing the metal powder used in the embodiment of the present invention, in the present test, adhesive strength of the case (X) in which an epoxy bond 401 is used as an adhesive and adhesive strength of the case (Y) in which an epoxy bond 400 containing a metal powder is used as an adhesive are compared with each other using a specimen in which a coupling structure between the shaft 110 and the rotor case 210 is shaped according to the embodiment of the present invention.

The specimen includes the chamfer part 111 or 211 formed at all edge portions of the outer peripheral surface of the shaft 110 or the inner peripheral surface of the rotor case 210 on which the rotor case 210 is fixedly mounted to the shaft 110, and the epoxy bond or the epoxy bond containing the metal powder is filled in the chamfer part 111 or 211. Here, the epoxy bond containing the metal powder may contain about 30 wt % of metal powder.

Results obtained by performing a test of measuring force required to separate the adhesion portion using the X specimen (the specimen in the case in which the epoxy bond is used as the adhesive) and the Y specimen (the specimen in the case in which the epoxy bond containing the metal powder is used as the adhesive) provided as described above are shown in FIG. 8.

Referring to FIG. 8, separation force of the X specimen is about 44 Kgf; however, separator force of the Y specimen is about 54 Kgf. As a result, it may be confirmed that the separation force of the Y specimen has increased as compared to the separation force of the X specimen by about 20%.

As set forth above, with the motor and the recording disk driving device including the same according to the embodiments of the present invention, coupling strength between the shaft and the rotor case that have a small contact area therebetween and between the sleeve and the cover member that also have a small contact area therebetween may be improved.

In addition, the chamfer or groove is formed at a portion at which each member is coupled to each other to increase shear strength, whereby coupling strength between each member may be further improved.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a shaft; and
a rotor case fixedly mounted to the shaft to thereby rotate together therewith,
a portion of the rotor case and the shaft fixedly mounted to each other having an adhesive containing a metal powder interposed therein.

2. The spindle motor of claim 1, wherein an edge portion of at least one of an outer peripheral surface of the shaft and an inner peripheral surface of the rotor case, on which the rotor case is fixedly mounted to the shaft, is provided with at least one chamfer part, and
the adhesive containing the metal powder is applied to the chamfer part.

3. The spindle motor of claim 2, wherein the chamfer part is formed to have a ring shape along the outer peripheral surface of the shaft and the inner peripheral surface of the rotor case.

4. The spindle motor of claim 1, wherein at least one of the outer peripheral surface of the shaft and the inner peripheral surface of the rotor case on which the rotor case is fixedly mounted to the shaft is provided with at least one groove, and
the adhesive containing the metal powder is applied to the groove.

5. The spindle motor of claim 4, wherein the groove is formed to have a ring shape along the outer peripheral surface of the shaft or the inner peripheral surface of the rotor case.

6. The spindle motor of claim 4, wherein the groove is formed to have a screw thread shape along the outer peripheral surface of the shaft or the inner peripheral surface of the rotor case.

7. The spindle motor of claim 1, wherein the rotor case is press-fitted onto the shaft.

8. The spindle motor of claim 1, wherein the rotor case has an inner diameter larger than an outer diameter of the shaft.

9. A spindle motor comprising:
a sleeve supporting a shaft; and
a cover member fixedly mounted to a lower end of the sleeve to thereby prevent leakage of lubricating fluid,
a portion of the cover member and the sleeve fixedly mounted to each other having an adhesive containing a metal powder interposed therein.

10. The spindle motor of claim 9, wherein an edge portion of at least one of an inner peripheral surface of the sleeve and an outer peripheral surface of the cover member on which the cover member is fixedly mounted to the sleeve is provided with at least one chamfer part, and
the adhesive containing the metal powder is applied to the chamfer part.

11. The spindle motor of claim 10, wherein the chamfer part is formed to have a ring shape along the inner peripheral surface of the sleeve or the outer peripheral surface of the cover member.

12. The spindle motor of claim 9, wherein at least one of the inner peripheral surface of the sleeve and the outer peripheral surface of the cover member on which the cover member is fixedly mounted to the sleeve is provided with at least one groove, and
the adhesive containing the metal powder is applied to the groove.

13. The spindle motor of claim 12, wherein the groove is formed to have a ring shape along the inner peripheral surface of the sleeve or the outer peripheral surface of the cover member.

14. The spindle motor of claim 12, wherein the groove is formed to have a screw thread shape along the inner peripheral surface of the sleeve or the outer peripheral surface of the cover member.

15. The spindle motor of claim 9, wherein the cover member is press-fitted into the sleeve.

16. The spindle motor of claim 9, wherein the sleeve has an inner diameter larger than an outer diameter of the cover member.

17. A recording disk driving device comprising the spindle motor of claim 1 rotating a recording disk.
